(19) United States
(12) Patent Application Publication
(10) Pub. No.: US 2017/0254443 A1
(43) Pub. Date: Sep. 7, 2017

(54) METHOD FOR THE PRODUCTION OF A TUBULAR MEMBER, AND TUBULAR MEMBER

(71) Applicant: Mahle International GmbH, Stuttgart (DE)

(72) Inventor: Thomas Schiehlen, Altheim (DE)

(21) Appl. No.: 15/506,728

(22) PCT Filed: Aug. 26, 2015
(86) PCT No.: PCT/EP2015/069556

§ 371 Date: Feb. 24, 2017

(30) Foreign Application Priority Data
Aug. 27, 2014 (DE) 10 2014 217 078.8

(51) Int. Cl. F16L 9/00; C09J 7/02; B32B 7/12; B32B 1/08; B21C 37/15; F24F 13/02; F16L 9/17; C09J 5/06; B32B 15/04

(52) U.S. Cl. CPC F16L 9/003; C09J 5/06; C09J 7/0296; B32B 7/12; B32B 15/04; B21C 37/151; F24F 13/0209; F16L 9/17; B32B 1/08; C09J 2400/163; C09J 2201/61

(57) ABSTRACT

A method for producing a tubular member from a metal sheet may include applying an adhesive layer to at least one joining section of at least two associated joining sections of the metal sheet, forming the metal sheet into a tubular member such that the at least two associated joining sections may be arranged on one another, and heating the adhesive layer by rolling a first roll over the metal sheet.

### CROSS-REFERENCE TO RELATED APPLICATIONS

This application claims priority to German Patent Application No. DE 10 2014 217 078.8, filed on Aug. 27, 2014, and International Patent Application No. PCT/EP2015/069556, filed on Aug. 26, 2015, both of which are hereby incorporated by reference in their entirety.

### TECHNICAL FIELD

The present invention relates to a method for producing a tubular member from a metal sheet. The invention further relates to such a tubular member.

### BACKGROUND

Usually a fluid flows in a tubular member. Accordingly, tubular members are used in applications in which the flow of a fluid is required. Such a tubular member can be used, for example, in a tempering device through which a fluid flows for tempering purposes. Tubular members can be made of plastic. Frequently however tubular members are made of a metal in order to achieve a high stability and/or media resistance of the tubular member. In order to produce such a tubular member, a metal sheet can be used which is formed into a tube and then soldered or welded. However, the soldering and the welding of the metal sheet require a high energy requirement as a result of the high temperatures required and thus result in increased production costs. Furthermore, additional means are necessary for this, e.g. the application of a soldering agent, or solder for short, for soldering, which necessitates a previous degreasing and/or de-oxidation to break up an oxide layer. Usually chemical substances which are harmful to health are used, which constitute a corresponding hazard for the persons involved in the manufacture and must be removed without any residue. These types of joining additionally require a subsequent checking of the tubular member for tightness and a possible reworking of the tubular member to ensure tightness which also requires additional working steps and resources.

Known from U.S. 2004/148992 A1 is a method for producing a tubular member in which a metal sheet is provided with joining sections at the ends, which are then brought into engagement with one another and adhesively bonded in order to form the tubular member.

U.S. Pat. No. 2,998,339 A discloses a method for producing a tubular member in which are plurality of metal sheets are successively wound around a common core so that the metal sheets lies one above the other. The superposed metal sheets are then connected to form the tubular member by heating an adhesive.

### SUMMARY

The present invention is therefore concerned with the problem of providing a method for the production of a tubular member, preferably a tempering device, and to provide improved or at least different embodiments for such a tubular member which are characterized by a more cost-effective and/or simple manufacture.

This problem is solved according to the invention by the subject matter of the independent claim(s). Advantageous embodiments are the subject matter of the dependent claims.

The present invention is based on the basic idea of producing a tubular member from a metal sheet and thermally bonding the metal sheet to form the tubular member. For this purpose at least one adhesive layer is used which joins the two joining sections of the metal sheet to one another. According to the invention it is provided that an adhesive layer is applied to at least one such joining section and the metal sheet is formed into the tubular member. In this case, the adhesive layer can be applied before the forming, during the forming and after the forming of the metal sheet. In this case, the forming of the metal sheet takes place in such a manner that at least two associated joining sections are arranged on one another to form the tubular member. For joining the joining sections the adhesive layer is heated in order to achieve the thermal bonding. Consequently, an inexpensive, effective production of the tubular member using relatively few resources is possible. In particular, the use of additional chemical agents, for example, for degreasing or for removal of an oxidation layer of the metal sheet can be dispensed with.

The heating of the adhesive layer preferably results in a change in shape and/or change in structure of the adhesive layer which enables and in particular facilitates a joining of the joining sections. Such a change in the adhesive layer is for example a softening and/or a melting and/or an expansion and/or a hardening of the adhesive layer.

The joining between the associated joining sections by means of the adhesive layer preferably achieves a stable state after the adhesive layer cools following heating. This is in particular the case when the adhesive layer cures.

This process, that is the change in shape and/or change in structure and/or the curing of the adhesive layer, can be reversible. As a result, the joining of the joining sections can be released if required by appropriately heating the adhesive layer.

As a result of the method according to the invention it is possible to use adhesive layers having a small layer thickness. In particular, it is possible to use adhesive layers which have a layer thickness of a few micron. In this case, variants are preferred in which the layer thickness of the adhesive layer is between 5 μm and 500 μm.

When heating the adhesive layer for joining the joining sections, a temperature which lies above the operating temperature of the tubular member is advantageously required. That is, the tubular member during operation reaches extremely high temperatures which are advantageously below the melting point of the adhesive layer. In this way, it is ensured that the join between the joining sections is not released during operation of the tubular member.

The adhesive layer comprises at least one adhesive. In this case, the adhesive layer, in particular the at least one adhesive is selected and/or conditioned in such a manner that a temperature between 120° C. and 400° C. during heating of the adhesive layer is sufficient to join the associated joining sections. Examples for such adhesives are Makrofol®, Bayfol®, Kleberit 701.1-701.9 and the like.

The adhesive layer advantageously comprises those adhesives which have thermoplastic properties. That is, the adhesive can be deformed above an adhesive-specific temperature which preferably corresponds to the temperature during heating of the adhesive layer for joining the components.

The adhesive layer is applied in an arbitrary manner to the associated joining sections. Preferably the adhesive layer is configured as an adhesive foil or an adhesive film. In this way, it is possible to provide the associated joining section with the adhesive layer in a simple and reliable manner, in particular in a surface-covering manner. It is hereby in particular ensured that the joining sections are joined stably and tightly to one another so that an appurtenant tightness of the tubular member is ensured.

In preferred variants the adhesive layer, in particular such an adhesive foil and/or such an adhesive film is laminated onto the associated joining sections. Lamination of the adhesive layer to the associated joining section enables a rapid and simple application of the adhesive layer to the joining section. In particular, many joining sections can thus be provided with such an adhesive layer in a short time.

Naturally it is also possible to join a plurality of joining sections with the same adhesive layer to one another. As a result, the expenditure for producing the tubular member is reduced appreciably. In particular, the measures and/or resources required for joining a plurality of joining sections to one another are reduced.

Embodiments are preferred in which the adhesive layer is heated for less than 10 minutes for joining the joining sections. Such a short duration of the heating of the adhesive layer results in reduced energy consumption for producing the tubular member so that the tubular member can be produced inexpensively and in an environmental friendly manner. Such a short required duration of the heating is achieved in particular by a corresponding choice of adhesive layer and/or layer thickness of the adhesive layer.

According to the invention, the adhesive layer is heated with the aid of a roll, which in particular can be configured as a roller. To this end, the roll, in particular the roller, can be heated. For heating the adhesive layer, the roll is rolled over the metal sheet formed into the tubular member, preferably over the associated joining section. By this means it is possible to successively heat a plurality of joining sections and/or different regions of such a joining section successively.

In order to ensure a better or more stable joining between the associated joining sections, these joining sections are preferably pressed against one another with a contact pressure during the joining process. This can take place before the heating of the adhesive layer. It is also feasible to press the joining regions against one another during and/or after the heating. This results in a better or more stable joining of the joining sections with the adhesive layer and/or with one another.

The contact pressure in this case can be arbitrarily large or small. The limits of the contact pressure are here given on the one hand by the fact that the contact pressure should result in an improved joining of the joining sections and on the other hand no undesired damage should be caused to the joining sections. The method is preferably configured in such a manner that contact pressures between 0.1 N/mm² and 0.7 N/mm² are applied for this purpose.

The contact pressure can be produced in an arbitrary manner. For this purpose, for example, the first roll can be used, which in addition to heating the adhesive layer also brings about the pressing of the joining sections against one another. For this purpose, for example, the roll can have a corresponding weight.

It is also feasible to achieve the contact pressure by a second roll. The use of such a separate roll has the advantage that the heating of the adhesive layer and the production of the contact pressure can take place separately, in particular independently. In this case, it is in particular possible that the first roll and the second roll simultaneously act on the adhesive layer or on the joining sections in which, for example, the first roll acts on such joining sections whereas the second roll acts on another joining section wherein these joining sections are not necessarily associated.

Alternatively, initially the first roll and then the second roll can be used. In this case, it is possible that the first roll and the second roll act on the same joining section. It is also possible that the first roll acts on such a joining section whilst the second roll acts on the associated joining section.

An acceleration of the joining process and/or a shortening of the time required for joining the joining sections can be achieved by cooling the adhesive layer following the heating. Such a cooling is usually accompanied by the termination of the heating of the adhesive layer. It is also conceivable to actively cool the adhesive layer. For this purpose, the adhesive layer, in particular the tubular member can be exposed to a lower ambient temperature by bringing the tubular member for example into a cooled environment. It is also conceivable to bring the tubular member, in particular the joining sections or the adhesive layer, in contact with a cooled object.

In advantageous variants, the cooling of the adhesive layer is accomplished by the second roll. This is achieved, for example, by the second roll having a lower temperature than the first roll. That is, in particular that the second roll is not heated. It is also conceivable to cool the second roll in order to thus achieve a corresponding active cooling of the adhesive layer.

In further variants, the heating of the adhesive layer takes place in a furnace. By this means it is possible to join a plurality of associated joining sections in the furnace simultaneously or consecutively by heating the associated at least one adhesive layer. Also associated joining sections of a plurality of tubular members can be joined simultaneously by simultaneously or consecutively heating the respective adhesive layers. This can be implemented for example by introducing a plurality of formed metal sheets and/or metal sheets provided with the adhesive layer simultaneously or consecutively into the furnace.

The use of the furnace for heating the adhesive layer can be accomplished in this case in such a manner that the respective adhesive layer is guided through the furnace for a predefined time, wherein the predefined time in particular corresponds to the time required for heating the adhesive layer for joining the associated joining sections. As a result, it is in particular possible to implement the heating of the adhesive layers in the manner of an assembly line which passes through the furnace.

In order to arrange associated joining sections of the metal sheet on one another, it is conceivable to bend the metal sheet during forming. In this case, the metal sheet can be bent differently at different points. That is, the bent sheet metal can have different bending radii. The respective bending radius is arbitrarily large or small provided that a corresponding arrangement of associated joining sections on one another is possible. As a result, it is in particular possible to configure the tubular member as a folded tube or as a flat tube. Such a flat tube in this case has a width in cross-section which is greater than the height. Preferably the width is twice to five times greater than the height. The length is preferably at least twice, in particular at least five times the width.

It is understood that in addition to the method for producing the tubular member according to the invention, such a tubular member produced according to the invention also pertains to the scope of the invention.

Further important features and advantages of the invention are obtained from the subclaims, from the drawings and from the relevant description of the figures with reference to the drawings.

It is understood that the aforesaid features and those still to be explained can be used not only in the respectively given combination but also in other combinations or alone without departing from the scope of the present invention.

Preferred exemplary embodiments of the invention are presented in the drawings and are explained in detail in the following description where the same reference numbers relate to the same or similar or functionally the same components.

### BRIEF DESCRIPTION OF THE DRAWINGS

In the figures, schematically

FIGS. 1 to 4 each show a cross-section in different process steps to produce a tubular member,

FIG. 5 shows a view from FIG. 4 in a process step to produce the tubular member in a different embodiment,

FIG. 6 shows the view from FIG. 5 in a further process step,

FIG. 7 shows a cross-section corresponding to FIG. 4 in a different embodiment,

FIG. 8 shows a view from FIG. 7 in a further embodiment,

FIG. 9 shows a cross-section corresponding to FIG. 4 in a further embodiment,

FIG. 10 shows a process step to produce the tubular member, different embodiment,

FIG. 11 shows a schematic view to produce a tubular member,

FIG. 12 shows a cross-section through a tempering device.

### DETAILED DESCRIPTION

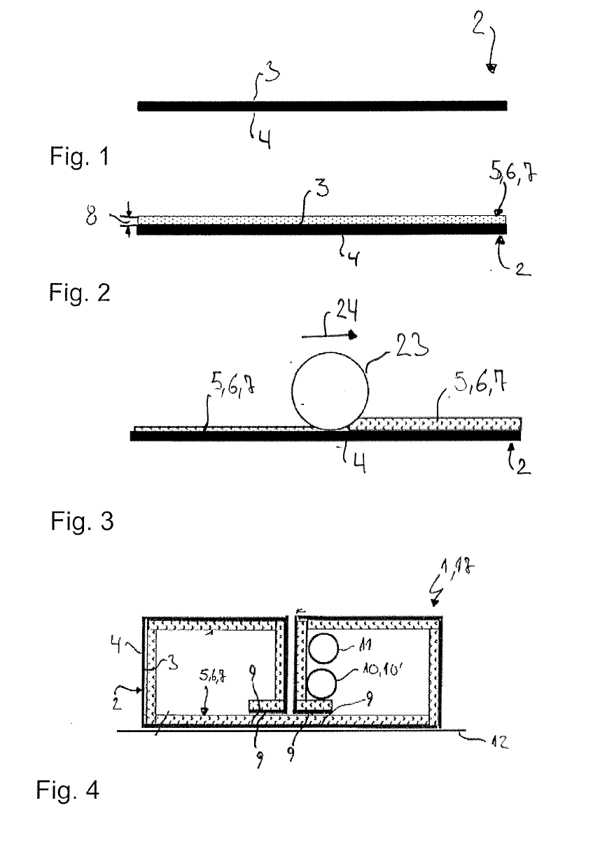

FIGS. 1 to 4 show different process steps to produce a tubular member 1 through which flow can take place. As shown in FIG. 1, the starting material is a metal sheet 2 which has an upper side 3 and a lower side 4 opposite the upper side 3. In this case, cross-sections through the metal sheet 2 or the tubular member 1 are shown in each case in FIGS. 1 to 4.

According to FIG. 2, an adhesive layer 5 is applied to the upper side 3 and/or to the lower side 4 of the metal sheet 2, wherein in the example shown only the upper side 3 is provided with such an adhesive layer. In addition, in the example shown the adhesive layer 5 extends over the entire width of the metal sheet 2. Preferably the adhesive layer 5 also extends over the length of the metal sheet 2. The adhesive layer 5 is configured as an adhesive foil 6 laminated onto the metal sheet 2 or as adhesive film 7. The adhesive layer 5 has a layer thickness 8 which lies between 5 μm and 500 μm.

As shown in FIG. 3, the adhesive foil 6 is heat-treated for laminating onto the metal sheet 2. In the example shown this is accomplished by a heatable laminating roller 23 which in the heated state is rolled over the metal sheet 2 provided with the adhesive foil 6 where the direction of movement of the laminating roller 23 is indicated by an arrow 24.

The application of the adhesive layer 5 is followed by forming, in particular bending of the metal sheet 2 provided with the adhesive layer 5 to form the tubular member 1, as shown in FIG. 4. Here the metal sheet 2 is bent at several places in the direction of the upper side 3 so that bending radii are formed at corresponding locations. In the example shown in FIG. 4 these bending radii are so small that the metal sheet 2 is almost folded at the corresponding locations. The tubular member 1 is produced by joining the at least two associated joining sections 9 of the metal sheet 2. In this case, the adhesive layer 5 is applied to at least one of the associated joining sections 9. In the example shown, as described previously, this is implemented by providing the upper side 3 of the metal sheet 2 with such an adhesive layer 5 at least over the entire width. In the example shown, two pairs of such joining sections 9 are used to produce the tubular member 1.

To this end, the adhesive layer 5 is initially heated in the area of at least one such joining section 9. In the present example, the heating of the adhesive layer 5 is achieved with the aid of the first roll 10, which is heatable and can be configured as first roller 10′. For heating the adhesive layer 5 the first roll 10 is rolled over the associated joining region 9 or the adhesive layer 5 on the corresponding joining region 9. In the example shown, the first roll 10 is positioned on the adhesive layer 5 which is applied to such a joining section 9′ where this joining section 9′ is arranged with the adhesive layer 5 on the associated joining section 9″. During heating of the first roll 10, the adhesive layer 5 arranged between the joining sections 9 is therefore heated via the joining section 9′ arranged between the adhesive layers 5. The heating is accomplished in such a manner that the adhesive layer 5 arranged between the joining sections 9 is heated to a temperature between 120° C. and 400° C. At these temperatures a change in shape and/or a change in structure of the adhesive layer 5 takes place. In particular, the adhesive layer 5 is softened and/or melted or activated as a result. The associated joining sections 9 are then pressed against one another with a contact pressure. In the example shown in FIG. 4 this is accomplished with the aid of a second roll 11 which acts on one of the associated joining sections 9 and thus presses this against the associated joining section 9. In this case, FIG. 4 shows a state of the second roll 11 in which the second roll 11 follows behind the first roll 10 so that after the first roll 10 moves away from the indicated position, the second roll 11 is brought into this position and the associated joining sections 9 are pressed against one another, wherein the underside 4 of the metal sheet 2 is arranged on a base 12. The associated joining sections 9 are preferably pressed against one another until the adhesive layer 5 has reached a stable shape and/or structure. That is, the associated joining sections 9 are pressed together in particular until the adhesive layer 5 cures.

When the associated joining sections 9 are pressed against one another, contact pressures are produced which preferably lie between 0.1 N/mm² and 0.7 N/mm². As a result, a stable joining between the joining sections 9 is possible where no undesired formings and/or damage to the metal sheet 2 or tubular member 1 are caused.

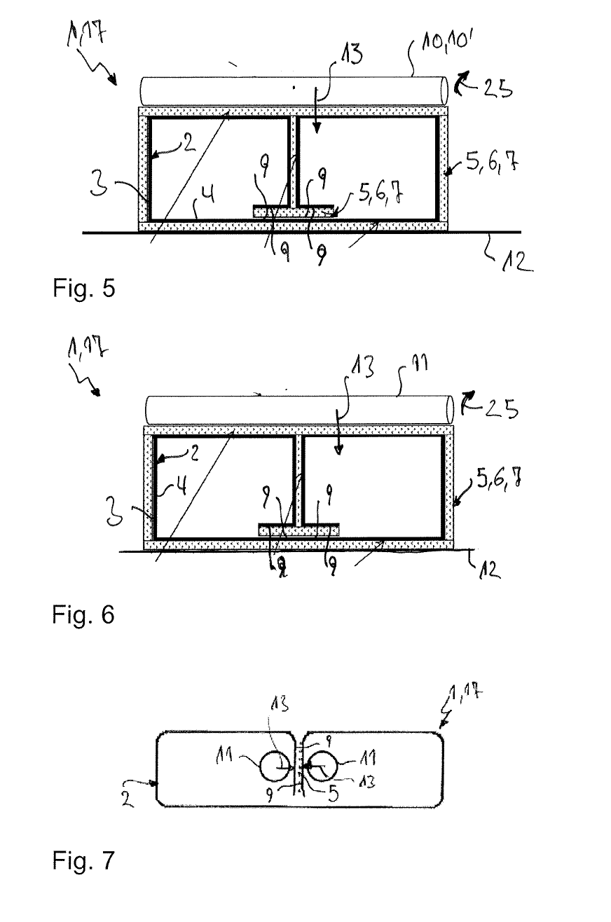

FIG. 5 shows another embodiment for producing the tubular member 1. This embodiment differs from the embodiment shown in FIGS. 1 to 4 substantially in that the metal sheet 2 is formed into the tubular member 1 in such a manner that the adhesive layer 5 is arranged on the outside of the metal sheet 2 formed into the tubular member 1. In addition, the first roll 10 or roller 10′ is rolled on the outside on the metal sheet 2 formed into the tubular member 1 over the metal sheet 2 formed into the tubular member 1. In this case, the heatable first roller 10 is rolled in the heated state on the underside 4 facing away from the joining sections 9 and the base 12 over the metal sheet 2 formed into the tubular member 1. The said heating of the adhesive layer 5 takes place as a result. In addition, pressure is applied with the first roll 10 to the metal sheet 2 formed into the tubular member 1 and thus the contact pressure is applied, where the contact pressure is indicated by an arrow 13.

In addition, as shown in FIG. 6, it is possible to make the second roll 11 roll after the first roll 10 so that in particular the contact pressure is built up or maintained. In this example, the second roll 11 therefore follows the first roll 10, where the direction of the respective roll 10, 11 is indicated by a curved arrow 25.

FIG. 6 shows another embodiment of the tubular member 1 and of the method of production. Compared to the previous example, the entire metal sheet 2 is not provided with the adhesive layer 5. The adhesive layer 5 is merely applied to at least one of the associated joining regions 9 wherein only a single pair of such associated joining sections 9 is provided in the example shown. In addition, the metal sheet 2 is bent with larger bending radii compared to the example shown in FIG. 3. Furthermore, the contact pressure for pressing the joining sections 9 against one another is produced with the aid of two such second rollers 11. These are attached to sides of the joining sections 9 facing away from the adhesive layer 5 and thus arranged opposite one another. The contact pressure is produced by moving the second rollers 11 towards one another as is indicated by the arrows 13 and by rolling along the metal sheet 2 formed into the tubular member 1.

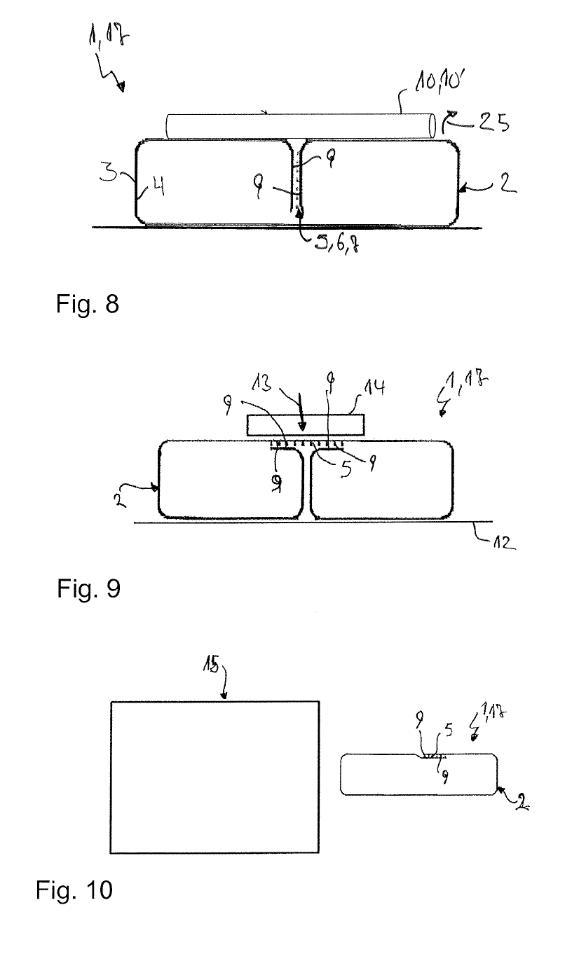

FIG. 8 shows another embodiment for producing the tubular member 1. In this embodiment, the metal sheet 2 is provided with the adhesive layer 5 and formed according to the embodiment shown in FIG. 7. The adhesive layer is heated on the metal sheet 2 formed into the tubular member 1 similarly to FIG. 5 by means of the heatable first roll 10 or roller 10′ which are rolled along the underside 4 or on the outside along the metal sheet 2 formed into the tubular member 1.

In all the embodiments shown a more rapid joining and/or more stable joining of the joining sections 9 is achieved by cooling the adhesive layer 5 between the joining sections 9. In this case, the cooling of the adhesive layer 5 can be accomplished with the aid of at least one such second roll 11.

As shown in FIG. 9, the contact pressure can also be implemented with the aid of a plate 14 which acts on at least one of the joining sections 9 and thus presses the joining sections 9 against one another. In the example shown in FIG. 9 the tubular member 1 is arranged on the base 12 where the joining sections 9 are facing away from the base 12. In this case, the plate 14 acts on the tubular member 1 or the joining sections 9 in such a manner that these are pressed in the direction of the base 12 in such a manner that said contact pressure is produced between the associated joining sections 9. The tubular member 1 shown in FIG. 9 is similar to the tubular member 1 shown in FIG. 4 where the tubular member 1 shown in FIG. 9 has larger bending radii. In addition, in the example shown in FIG. 9 the adhesive layer 5 is only applied in the area of the joining sections 9. The plate 14 is dimensioned in such a manner that it simultaneously exerts the contact pressure on all the joining sections 9 shown. The plate 14 can be used to heat the adhesive layer 5. To this end the plate 14 is heatable. Due to the dimensioning of the plate 14 it is further possible to simultaneously heat the adhesive layer 5 in the area of all the joining sections 9.

FIG. 10 shows a further variant of the tubular member 1 which has two associated joining sections 9. FIG. 10 additionally shows an alternative type of heating of the adhesive layer 5. Here a furnace 15 is used in which the tubular member 1 is arranged for heating the adhesive layer 5. This can be accomplished for example by guiding the tubular member 1 through the furnace 15. The time during which the tubular member 1 is located in the furnace 15 advantageously correlates with the time required for heating the adhesive layer 5 for joining the associated joining sections 9.

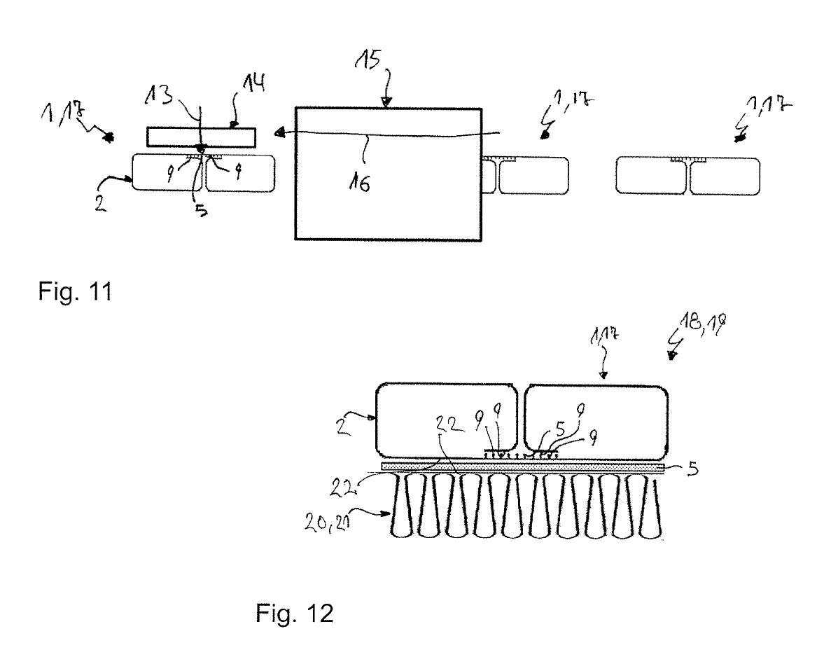

In this way, as shown in FIG. 11, a plurality of tubular members 1 can be consecutively arranged in the furnace 15 in the manner of an assembly line and guided through the furnace 15, where the direction of movement of the tubular member 1 is indicated by an arrow 16. Here the tubular member 1 shown in FIG. 9 is shown merely as an example in FIG. 11. In FIG. 11 the associated joining sections 9 are pressed against one another with the aid of such a plate 14. In this case, the generation of the contact pressure by means of the plate 14 can begin in the furnace 15. That is, the plate 14 is already acting on the joining sections 9 in the furnace 15 and is moved with the tubular member 1 from the furnace 15.

In FIGS. 4 to 11 the metal sheet 2 is in each case formed in such a manner purely as an example that the tubular member 1 is configured as a flat tube 17. Naturally it is also possible to form the respective tubular member 1 differently.

FIG. 12 shows a tempering device 18 which for example is configured as heat exchanger 19. The tempering device 18 comprises the tubular member 1 and another component 20 which in the present case is configured as a ribbed structure 21 or corrugated ribbed structure 21. The component 20 is also bonded thermally with the tubular member 1 to produce the tempering device 18. To this end, such an adhesive layer 5 is arranged between the tubular member 1 and the component 20. In this case, associated joining regions 22 of the component 20 and the tubular member 1 are joined to one another. To this end such an adhesive layer 5 is applied to at least one of the joining regions 22. The adhesive layer 5 is heated for joining the joining regions 22.

Overall the adhesive layer 5 for producing the tubular member 1 and the adhesive layer 5 for joining the component 20 to the tubular member 1 can be heated simultaneously and/or in a common process step in order to produce the tubular member 1 on the one hand and the tempering device 18 on the other hand. That is, the tempering device 18 and the tubular member 1 are in this respect produced jointly. For this purpose the tempering device 18 shown in FIG. 12 can be introduced into such a furnace 15 for example. In this case, different adhesive layers 5 or different adhesive layers 5 can be used in each case.

It can be further identified in FIG. 12 that the joining sections 9 and the joining regions 22 partially overlap. In this case, the joining regions 22 are larger than the joining sections 9. Consequently a pressing of the joining sections 9 against one another can be achieved by pressing the connecting regions 22 against one another. This process step to produce the tubular member 1 and the tempering device 18 can therefore also be carried out in a common process step, in particular simultaneously.

1. A method for producing a tubular member from a metal sheet, comprising:
applying an adhesive layer to at least one joining section of at least two associated joining sections of the metal sheet;
forming the metal sheet into a tubular member such that the at least two associated joining sections are arranged on one another; and
heating the adhesive layer by rolling a first roll over the metal sheet.

2. The method according to claim 1, wherein applying the adhesive layer includes laminating one of an adhesive foil and an adhesive film onto the at least one joining section.

3. The method according to claim 1, wherein heating the adhesive layer includes heating the adhesive layer to a temperature between 120° C. and 400° C.

4. The method according to claim 1, wherein heating the adhesive layer includes heating the adhesive layer for less than 10 minutes.

5. The method according to claim 1, further comprising pressing the at least two associated joining sections against one another via a contact pressure at least one of during and after heating the adhesive layer.

6. The method according to claim 5, wherein the contact pressure between 0.1 N/mm² and 0.7 N/mm².

7. The method according to claim 5, wherein the contact pressure is produced by a second roll.

8. The method according to claim 7, further comprising rolling the second roll over the metal sheet after the first roll.

9. The method according to claim 1, further comprising cooling the adhesive layer after it has been heated.

10. The method according to claim 9, wherein cooling the adhesive layer includes using a second roll.

11. The method according to claim 1, further comprising bending the metal sheet such that the at least two associated joining sections are arranged on one another.

12. A tubular member manufactured according to a method comprising:
applying an adhesive layer to at least one joining section of at least two associated joining sections of a metal sheet;
forming the metal sheet into a tubular member such that the at least two associated joining sections are arranged on one another; and
heating the adhesive layer by rolling a first roll over the metal sheet.

13. The tubular member according to claim 12, wherein the tubular member is configured as a flat tube.

14. The method according to claim 2, wherein heating the adhesive layer includes heating the adhesive layer to a temperature between 120° C. and 400° C.

15. The method according to claim 2, wherein heating the adhesive layer includes heating the adhesive layer for less than 10 minutes.

16. The method according to claim 2, further comprising pressing the at least two associated joining sections against one another via a contact pressure.

17. The method according to claim 16, wherein pressing the at least two associated joining sections against one another via a contact pressure includes pressing the at least two associated joining sections against one another via a contact pressure between 0.1 N/mm² and 0.7 N/mm².

18. The method according to claim 16, wherein pressing the at least two associated joining sections against one another via a contact pressure includes pressing the at least two associated joining sections against one another via a contact pressure produced by a second roll.

19. The method according to claim 17, wherein pressing the at least two associated joining sections against one another via a contact pressure includes pressing the at least two associated joining sections against one another via a contact pressure produced by a second roll.

20. A method comprising:
applying an adhesive layer to at least one joining section of at least two associated joining sections of a metal sheet;
bending the metal sheet into a tubular member such that at least two associated joining sections are arranged on one another;
heating the adhesive layer by rolling a first roll over the metal sheet;
pressing the at least two associated joining sections against one another via a contact pressure; and
cooling the adhesive layer by rolling a second roll over the metal sheet.
